(19) United States
(12) Patent Application Publication
(10) Pub. No.: US 2019/0093822 A1
(43) Pub. Date: Mar. 28, 2019

(54) GREASE CAP

(71) Applicants: Mike MCKINNON, Angus (CA); KLAUS 2000 INC., Oakville (CA)

(72) Inventor: Mike MCKINNON, Angus (CA)

(21) Appl. No.: 16/120,104

(22) Filed: Aug. 31, 2018

Related U.S. Application Data
(60) Provisional application No. 62/553,558, filed on Sep. 1, 2017.

(51) Int. Cl. F16N 21/06

(52) U.S. Cl. CPC F16N 21/06

(57) ABSTRACT

A grease cap having an outer ring portion which engages with an exterior surface of a grease cartridge, and an inner ring portion which engages with an interior surface of the grease cartridge. The outer and inner rings define a U-shaped circumferential groove for receiving the grease cartridge. The outer ring portion can include vents formed as indentations in the inner sidewall thereof. The vents can allow air to escape during installation of the grease cap.

### REFERENCE TO RELATED APPLICATIONS

This application claims priority from U.S. Provisional Application No. 62/553,558, filed Sep. 1, 2017, which is entirely incorporated by reference.

### FIELD OF THE INVENTION

The present invention pertains to the field of grease cartridges used for holding grease and in particular to a cap for sealing a grease cartridge.

### BACKGROUND

Cardboard and plastic grease cartridges are commonly used for holding and transporting grease products. The grease cartridges are typically cylindrical tubes and can be adapted to fit into a grease gun, for example. To stop the contents of the grease cartridge from escaping during storage and transport, a cap or a plug is typically placed over the open end of the cartridge. However, the caps and plugs can be prone to leakage and failure due to inadequate sealing and excess trapped air, for example. Moreover, standard plugs which are designed to plug a grease cartridge from the inside would not work for plastic cartridges at all due to the manufacturing/extrusion process, which leaves grooves on the inside of the cartridge which makes it impossible to seal a cartridge only from the inside.

Therefore there is a need for a grease cap that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a grease cap. In accordance with embodiments of the present invention, there is provided a grease cap for a grease cartridge, comprising: comprising a sealing member and a cover member connected to the sealing member. The sealing member comprises an outer ring member having an inner surface configured to sealingly engage with a cylindrical exterior surface of the grease cartridge, the outer ring member defining and surrounding a cylindrical cavity, an inner ring member having an outer surface configured to sealingly engage with a cylindrical interior surface of the grease cartridge, the inner ring member located within the cylindrical cavity, and a connecting body connecting a top edge of the inner ring member to a top edge of the outer ring member, wherein the sealing member and the cover member together define an enclosed space (or form a cap) for receiving an open top portion of the grease cartridge.

Further features and advantages of the present invention will become apparent from the following detailed description, taken in combination with the appended drawings, in which:

### BRIEF DESCRIPTION OF THE FIGURES

FIG. 1A illustrates a cross-sectional view of a grease cap for a grease cartridge, according to an embodiment of the present invention.

FIG. 1B illustrates an expanded portion of FIG. 1A for clarity.

FIG. 2 illustrates another cross-sectional view of the grease cap of FIG. 1A.

FIG. 3 illustrates the grease cap and grease cartridge assembly, according to an embodiment of the present invention.

FIG. 4 illustrates an exploded view of the grease cap and grease cartridge (tube) assembly, according to an embodiment of the present invention.

FIG. 5 illustrates a top view of the grease cap, according to an embodiment of the present invention.

FIG. 6 illustrates a bottom view of the grease cap, according to an embodiment of the present invention.

FIG. 7 illustrates a side view of the grease cap, according to an embodiment of the present invention.

FIG. 8A illustrates a bottom view of the grease cap, according to an embodiment of the present invention.

FIG. 8B illustrates an expanded portion of FIG. 8A for clarity.

FIG. 8C illustrates a cross-sectional view of a grease cap for a grease cartridge, according to another embodiment of the present invention.

FIG. 8 D illustrates an enlarged portion of a cross sectional view of an exemplary grease cap including exemplary dimensions.

FIG. 8E illustrates an enlarged portion of a cross sectional view of an exemplary grease cap including exemplary dimensions.

It will be noted that throughout the appended drawings, like features are identified by like reference numerals.

### DETAILED DESCRIPTION OF THE INVENTION

Unless defined otherwise, all technical and scientific terms used herein have the same meaning as commonly understood by one of ordinary skill in the art to which this invention belongs.

The present invention provides a grease cap with improved seal for fitting onto a grease cartridge, such as a hollow tubular or cylindrical grease cartridge. The grease cartridge can be made of plastic or cardboard (or other paper product).

The grease cap of the present invention comprises a sealing member and a cover member connected to the sealing member. The sealing member comprises an outer ring member, which defines and surrounds a cylindrical cavity, and has an inner surface configured to sealingly engage with a cylindrical outer surface of the grease cartridge. The sealing member also comprises an inner ring member located within the cylindrical cavity, and having an outer surface configured to sealingly engage with a cylindrical inner surface of the grease cartridge. The outer ring member and inner ring member are joined by a connecting body connecting a top edge of the inner ring member to a top edge of the outer ring member. The sealing member and the cover member together define an enclosed space (or form a cap) for receiving an open top portion of the grease cartridge.

The outer ring member is sized to provide a snug, sealing friction fit with the grease cartridge exterior when the grease cap is fully moved onto/engaged with (e.g. pressed and/or pulled due to vacuum) the grease cartridge.

The inner ring member is sized to fit inside of a grease cartridge with a snug, sealing friction fit with the grease cartridge interior when the grease cap is fully moved onto/engaged with the grease cartridge.

The region connecting the top edge of the inner ring member to the outer ring member is referred to for clarity as a connecting body. However, it should be noted that the connecting body can be formed by the extension and meeting of the top portion/edge of the outer ring member and the top portion/edge of the inner ring member. In a preferred embodiment, the connecting body has an inner face which is configured to engage with the top end/top edge face of the grease cartridge opening, to form a seal with the grease cartridge. In some embodiments, the inner face of the connecting body can be flat and have sufficient width to conform to the grease cartridge edge.

In some embodiments, an inner face of the connecting body is configured to sealingly engage with an edge face at an open end of the grease cartridge, wherein said sealing engagement occurs under vacuum pressure upon cooling of contents of the grease cartridge after the grease cap is installed on the grease cartridge.

In some embodiments, the cover member is connected at or adjacent to a bottom edge of the inner ring member.

In some embodiments, the edges of the cover member are integral with the bottom edge of the inner ring member.

In some embodiments, the cover member is connected at or adjacent to a top edge of the inner ring member.

In some embodiments, the cover member is connected to the connecting member.

In some embodiments, the top edge of the outer ring member, the top edge of the inner ring member, the connecting body and the edges of the cover member are integral.

The cover member can be flat or dome shaped.

In a preferred embodiment, the cover member is domed shaped having outer edges connected at or adjacent to the bottom edge of the inner ring member.

In some embodiments, the inner ring member of the grease cap further includes a lead-in protrusion, which extends from the bottom edge of the inner ring member towards the grease cartridge interior. The lead-in protrusion can be used to facilitate alignment of the grease cap with the grease cartridge, for example in an automated process.

In some embodiments, the grease cap can include a flexible portion and/or a resilient portion. For example, the connecting body and surrounding region can be flexed outward so that the outer ring member tends to move away from the inner ring member. This increases the distance between the inner surface of the outer ring member and the outer surface of the inner ring member. The movement is by flexure and involves the pivoting of the outer ring member and the inner ring member away from each other. This tends to widen the gap between the inner surface and the outer surface during insertion of the grease cartridge top into the gap between the outer ring member and the inner ring member.

The resiliency can bias the outer ring member and the inner ring member toward one another to grippingly engage the grease cartridge when placed between the outer ring member and the inner ring member. This facilitates the sealing engagement of the outer ring member inner surface against the grease cartridge exterior and the inner ring member outer surface against the grease cartridge interior. The gap between the outer ring member and the inner ring member may close to pinch or grip the grease cartridge, around the circumference of the grease cap and grease cartridge.

As such in view of the above, in the some embodiments, the grease cap of the present invention can be viewed as including a U-shaped sealing member (defined by the outer ring portion, the inner ring portion and the connecting member) having a width/gap for receiving and engaging the open top end/edge of a grease cartridge. The U-shaped sealing member can form up to three sealing engagements with the grease cartridge.

In particular, an inside seal can be provided by engagement of the inner ring outer surface with the interior surface of the grease cartridge. A top rim seal, also referred to as a compression seal, can be provided by engagement of the inner face of the connecting body against the top edge of the grease cartridge. The top rim seal can be facilitated by pressing the grease cap onto the grease cartridge with sufficient force to create contacting engagement and form the seal. An outer seal can be provided by engagement of the outer ring inner surface against the exterior surface of the grease cartridge. The two opposing sidewalls of the U-shaped region can be substantially flat and parallel to each other and to the sidewalls of the (e.g. cylindrical) grease cartridge. The portion of the U-shaped region connecting the two opposing sidewalls can be substantially flat and parallel to a top edge of the grease cartridge.

In some embodiments, one or more vents are provided in the grease cap, integrated into the outer ring member. The function of the vents is to facilitate the escape of excess air during installation of the grease cap on the grease cartridge.

A vent can be formed as a localized indentation in the inner surface of the outer ring member and/or the inner ring member. In some embodiments, the vent(s) are formed as a localized indentation in the inner surface of the outer ring member. In some embodiments, the vent(s) are located away from the top edge of the outer ring member, so that they do not interfere with/extend into the sealing engagement of the outer ring member with the grease cartridge. Thus, the vent(s) allow an air channel to be formed between the grease cartridge interior and the grease cartridge exterior, at least when the grease cap is partially installed. However, in various embodiments, when the grease cap is pressed further onto the grease cartridge, the air channel is cut off, due to the vents being separated from the cartridge top edge. In various embodiments, the vent occupies less than the entire circumference of the outer ring member. That is, the vent has an angular width in the circumferential direction which is less than 360 degrees. The angular width may be between about 5 and 30 degrees, for example. In various embodiments, a plurality of such vents, regularly spaced around the outer ring member, can be provided. This facilitates even venting of excess air during installation.

The grease cap can be made of plastic (e.g. polymeric material, such as polyethylene). The grease cap can also be made of metal (e.g. steel) for example through a molding process. In some embodiments, a single grease cap design can be used either with a paper or plastic grease cartridge.

The grease cap is substantially, but not necessarily completely, symmetric about a central axis of rotation. For example, some regions may include vents while others may not.

The grease cap of the present invention provides for the formation of multiple seals around the open end of the grease cartridge, which results in improved sealing effect and reduces and prevents any leakage which is a common complaint in the marketplace.

### Formation of Inside Seal

The grease may be placed into the grease cartridge while the grease is hot, and the cap placed onto the grease cartridge while the grease is still hot. The grease then cools. This cooling can assist in forming the seal, due for example to thermal contraction of the grease and optionally also of the cap and/or grease cartridge. The cooling effect can also be used to pull the grease cap onto the grease cartridge, due to a relative vacuum created within the grease cartridge interior due to cooling.

The seal can be created when vacuum is created as the grease is cooling. During this cooling, the inner ring member moves away from the center of the cartridge, due to cooling effects, and forces itself against the inside surface of the grease cartridge, this effectively creates a centering of the grease cartridge upon initial installation and helps to correct any deformities (such as an oval shape) found in a grease or paper cartridge. When grease inside the cartridge cools, it then afterwards seals the inside surface of the grease cartridge. The dome contracts and creates a pinch point thereby creating an inside seal. The gap between the outer ring member and the inner ring member closes to pinch or grip the grease cartridge, around the circumference of the grease cap and grease cartridge.

### Formation of Top Rim Seal

To form the top rim seal, the cap is compressed against the top of the cartridge upon installation of the grease cap onto the grease cartridge. This can be performed for either a plastic or paper cartridge. This is performed when the grease cap is pressed onto the grease cartridge.

Upon placement of the grease cap, the seal is centered to the top of the plastic or paper grease cartridge. The cooling down effect of the grease also helps seal the grease cap by pulling it downward on the compression seal.

### Formation of Outer Seal

The inner surface of the outer ring member forms a surface area contact seal against the outside of the grease cartridge. This contact seal helps stop seepage (leakage) of grease, for example due to a change in the grease viscosity during transit (e.g. due to climate or temperature changes) and/or due to reorientation of the grease cartridge from a vertical position to a horizontal position.

The outer seal can act as a contact seal and prevents the grease cap from rotating on the cartridge.

In some embodiments, the grease cap, or at least the outer ring member, is formed of a flexible, resilient, durable resin, such as low density polyethylene (LDPE). This can facilitate gripping of the grease cap when making contact. This can also inhibit breakage or cracking of the cap for example due to impact forces.

As discussed above, in some embodiments, at least one, and typically multiple air vents are provided and used to allow trapped air to escape while cap is being seated onto grease cartridge, thus allowing the dome of the cap to be drawn downwards creating the inside seal on the grease cartridge. The drawing of the grease cap downward may be due to the cooling effect of the grease, as described above.

Once the grease cap is drawn downward sufficiently to cut off the air vents, a certain amount of air may remain in the grease cartridge. In some embodiments, this remaining air is used to create a vacuum needed to pull the dome downwards. The vents can be configured to allow air to vent but prevent seepage of grease from occurring.

In some embodiments, the vents are designed and placed so that they do not advance beyond the pinch point created by the first seal against the grease cartridge.

In another aspect, the present invention provides a grease cap for a grease cartridge, which comprises an outer ring portion defining and surrounding a cylindrical cavity, and having an inner sidewall/surface configured to sealingly engage with a cylindrical outer surface of the grease cartridge, the outer ring portion; a top portion connected to a top edge of the outer ring portion. The outer ring portion and the top portion together define an enclosed space for receiving an open top portion of the grease cartridge. One or more vents are formed as localized indentations in the inner sidewall of the outer ring portion, wherein the vent(s) are located away from the top edge of the outer ring portion and occupying less than the entire circumference of the outer ring portion.

In some embodiments, the grease cap comprises a plurality of regularly spaced vents, wherein each vent is formed as a localized indentation in the inner sidewall of the outer ring portion, each vent located away from the top edge of the outer ring portion and occupying less than the entire circumference of the outer ring portion.

In some embodiments, the top portion comprises an inner ring portion, a connecting body connecting a top edge of the inner ring portion to a top edge of the outer ring portion, and a cover piece.

In some embodiments, the cover piece is connected to a bottom edge of the inner ring portion.

In some embodiments, the cover piece is connected to a top edge of the inner ring portion.

In some embodiments, the inner ring portion is located within the cylindrical cavity and comprises an outer sidewall configured to sealingly engage with a cylindrical inner surface of the grease cartridge.

In some embodiments, an inner face of the connecting body is configured to sealingly engage with an edge face at an open end of the grease cartridge, wherein said sealing engagement occurs under vacuum pressure upon cooling of contents of the grease cartridge after the grease cap is installed on the grease cartridge.

The grease cap of the present invention is less subject to leakage, for example due to the presence of multiple sealing elements acting in combination. The inner and outer rings also provide redundancy, which inhibits loss of an installed grease cap due to damage of one of the rings.

The cap of the present invention can to be used for both a paper cartridge and a plastic cartridge.

To gain a better understanding of the invention described herein, the following examples are set forth. It will be understood that these examples are intended to describe illustrative embodiments of the invention and are not intended to limit the scope of the invention in any way.

### EXAMPLES

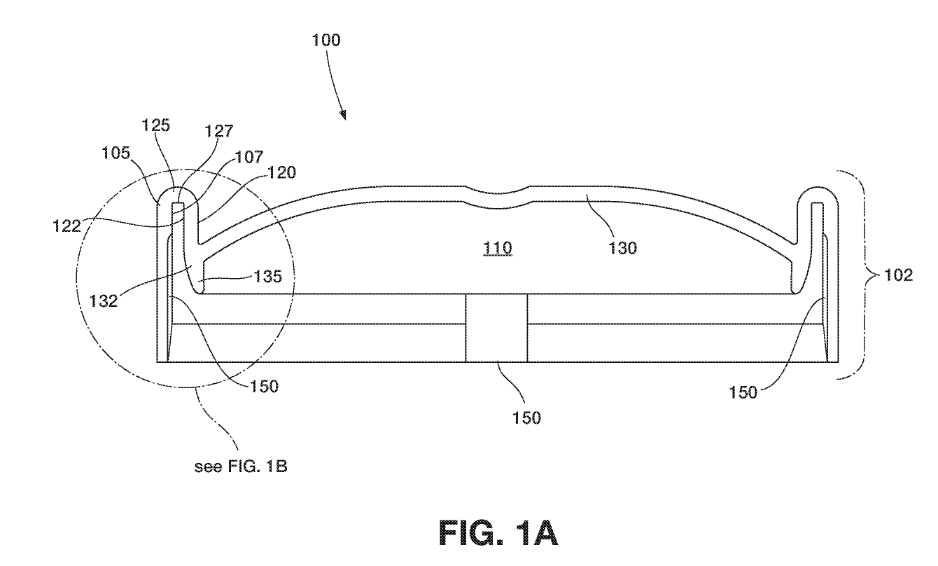

FIGS. 1A and 1B illustrate a cross-sectional view of a grease cap 100 for a grease cartridge, according to an embodiment of the present invention, comprising a sealing member 102, and a cover member 130.

The sealing member 102 includes an outer ring member 105 having an inner surface 107 configured to sealingly engage with a cylindrical exterior surface of the grease cartridge. The outer ring member defines and surrounds a cylindrical cavity 110.

The sealing member 102 further comprises an inner ring member 120 having an outer surface 122 configured to sealingly engage with a cylindrical interior surface of the grease cartridge. The inner ring member 120 is located within the cylindrical cavity 110. The inner ring member is sized to fit inside of a grease cartridge with a snug, sealing friction fit with the grease cartridge interior when the grease cap is fully moved onto the grease cartridge.

In the illustrated embodiment, the inner ring member 120 is connected to the outer ring member 105 via connecting body 125, which is formed by the extension and meeting of the top edge of the outer ring member and the top edge of the inner ring portion. The connecting body has an inner face 127 which is configured to engage with the end/edge of the grease cartridge opening, to form a seal with the grease cartridge.

In the illustrated embodiment, the cover member 130 is dome-shaped (with the outer/upper convex surface), and is attached to the bottom edge 132 of the inner ring member.

As such, in view of the above, in the illustrated embodiment, the grease cap includes a U-shaped sealing member (defined by the outer ring member 105, the inner ring member 120 and the connecting member 125), having width/gap 140 for receiving and engaging the open top end of a grease cartridge. The U-shaped region can form up to three sealing engagements with the grease cartridge. In particular, an inside seal can be formed by the engagement of the inner ring outer surface 122 with the interior surface of the grease cartridge. A top rim seal, also referred to as a compression seal, can be formed by engagement of the inner face 127 of the connecting body against the top edge of the grease cartridge. The top rim seal can be facilitated by pressing the grease cap onto the grease cartridge with sufficient force to create contacting engagement and form the seal. An outer seal can be formed by engagement of the outer ring member inner surface 107 against the exterior surface of the grease cartridge.

In the illustrated embodiment, the inner ring member further includes a lead-in protrusion 135 which protrudes from the bottom edge 132 thereof. The lead-in protrusion 135 can be used to facilitate alignment of the grease cap with the grease cartridge, for example in an automated process.

In the illustrated embodiment, the outer ring member 105 is provided with a plurality of vents 150, which are formed as localized indentations in the inner sidewall 107 of the outer ring member. The vents are located away from the top edge of the outer ring member, so that they do not extend into and interfere with the sealing engagement of the outer ring member with the exterior surface of the grease cartridge and the sealing engagement of the inner ring member with the inner surface of the grease cartridge. The vent(s) thus allow an air channel to be formed between the grease cartridge interior and the grease cartridge interior, at least when the grease cap is partially installed.

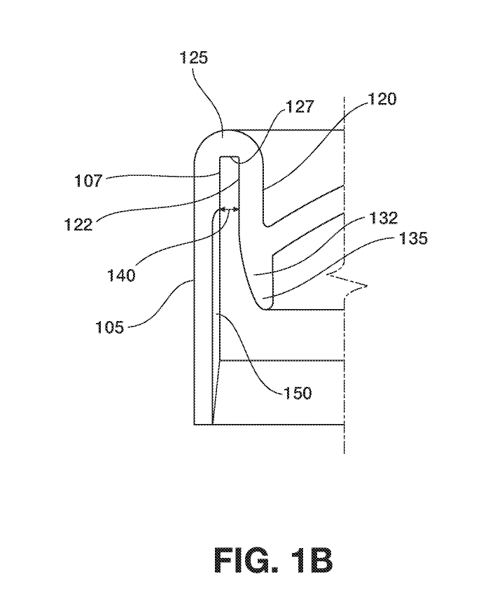

FIGS. 2 to 8 illustrate alternative views of the grease cap as illustrated in FIGS. 1A and 1B, as described below.

FIGS. 1A and 1B illustrate a cross section of the grease cap passing through the vents 150, whereas FIG. 2 illustrates a cross section of the grease cap which does not intersect any vents.

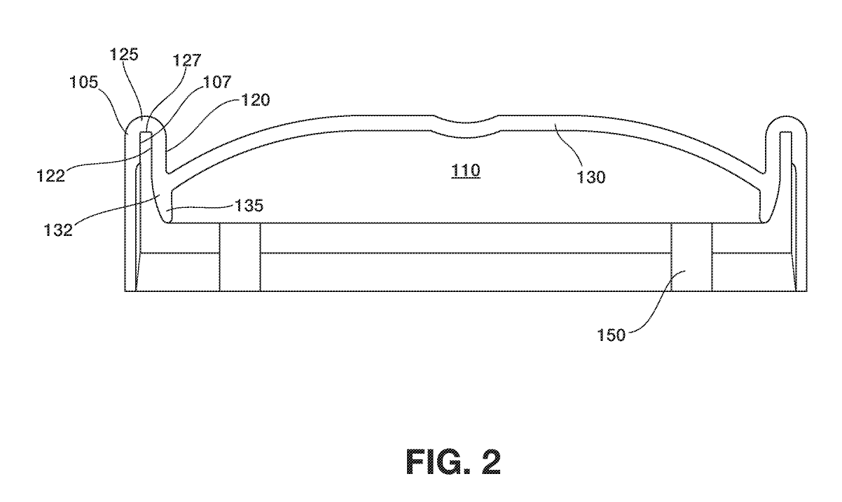

FIG. 3 illustrates the grease cap 100 (having outer ring member 105, inner ring member 120, connecting member 125 and cover member 130) and grease cartridge 200 (tube) assembled together, according to an embodiment of the present invention.

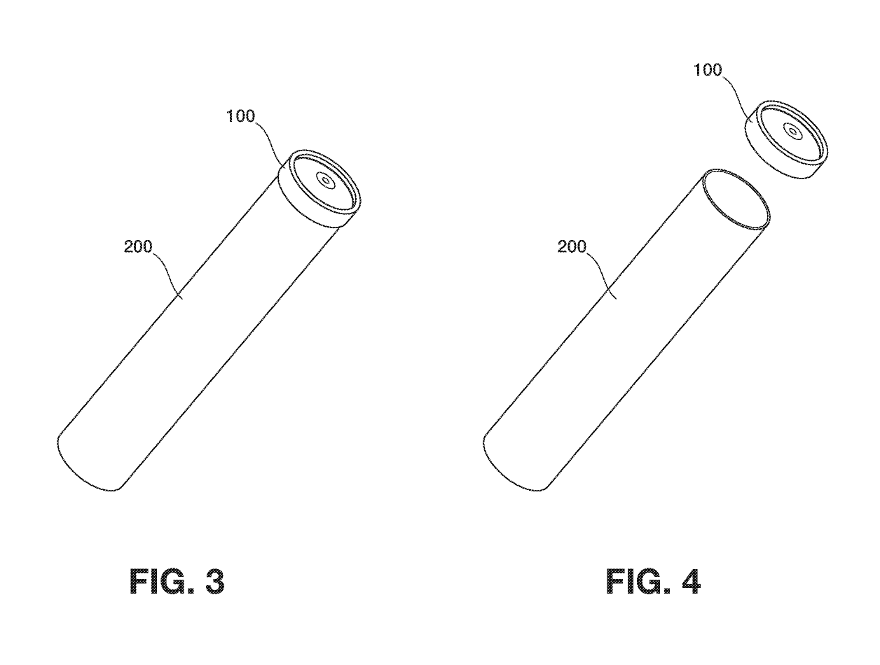

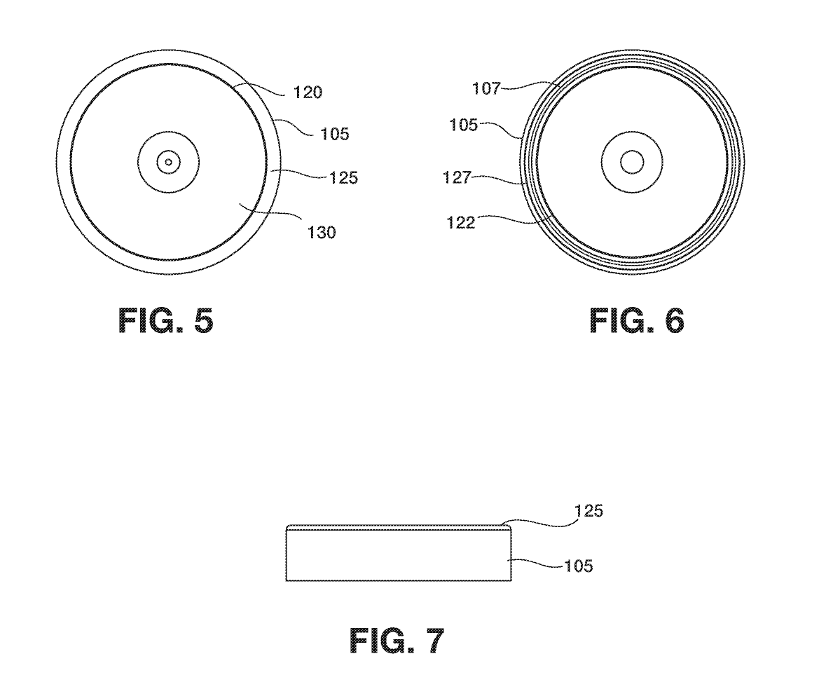

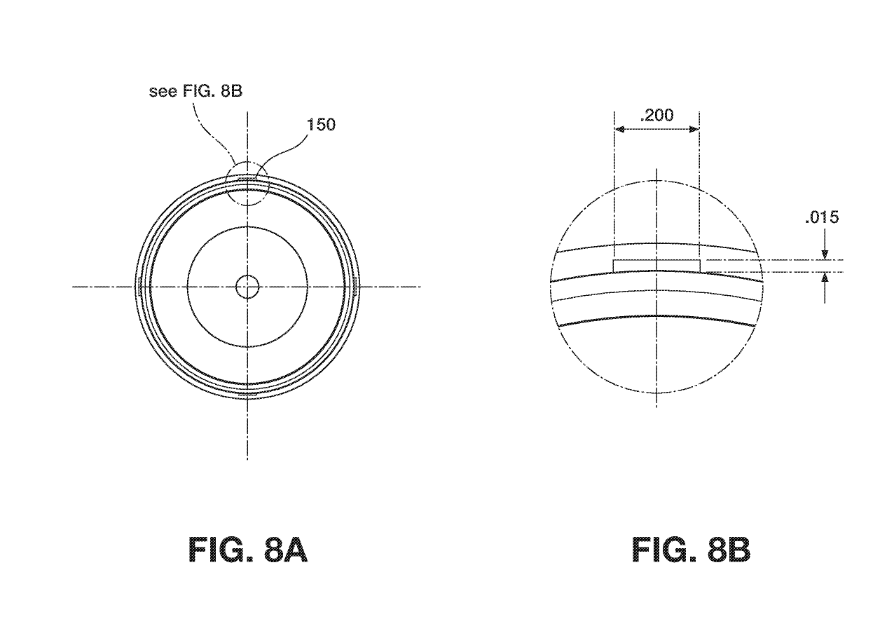

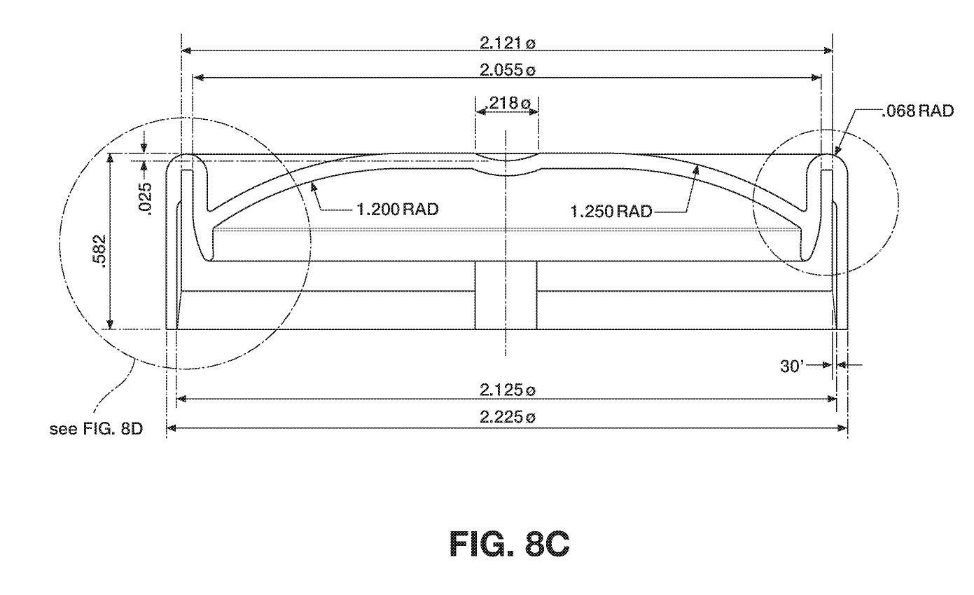

FIG. 4 illustrates an exploded view of the grease cap 100 and grease cartridge 200 (tube) assembly, according to an embodiment of the present invention. FIG. 5 illustrates a top view of the grease cap. FIG. 6 illustrates a bottom view of the grease cap. FIG. 7 illustrates a side view of the grease cap.

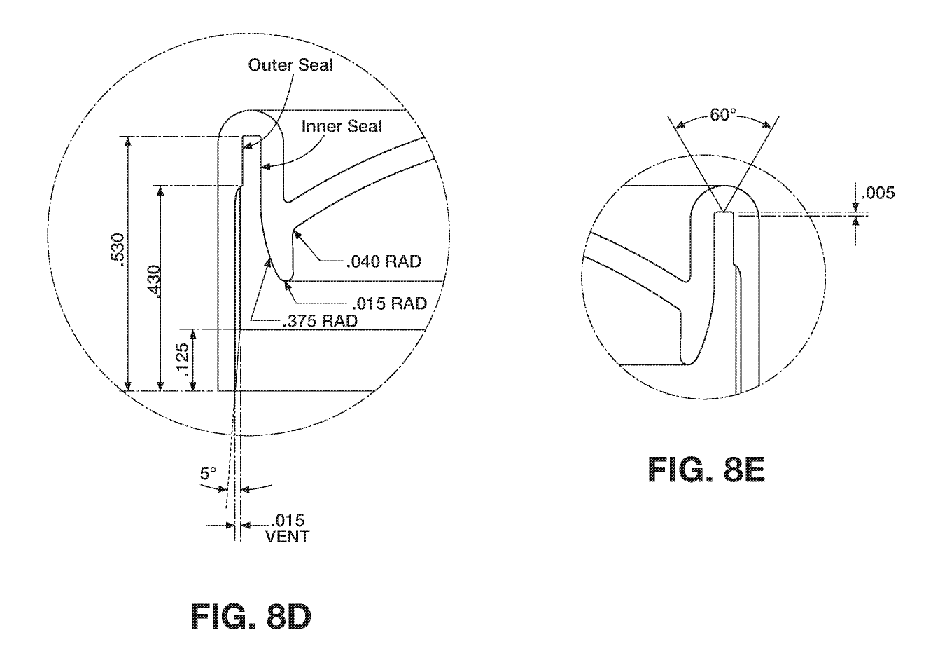

FIG. 8A illustrates a bottom view of an exemplary grease cap, showing vent 150. FIG. 8B illustrates an expanded portion of FIG. 8A including exemplary dimensions of the vent.

FIG. 8C illustrates a cross sectional view of an exemplary grease cap including exemplary dimensions of certain portions thereof.

FIG. 8 D illustrates an enlarged portion of a cross sectional view of an exemplary grease cap including exemplary dimensions of certain portions thereof.

FIG. 8 E illustrates an enlarged portion of a cross sectional view of an exemplary grease cap including exemplary of certain portions thereof. The 60 degree angle illustrated with respect to the top rim seal is used when machining the top of the core to create the compression seal that is used to seal the top of the grease cartridge, this creates a “V” shape seal that is compressed when installed on the cartridge.

In the illustrated embodiment, the presence of the dome shaped cover member and the lead-in protrusion further facilitate the formation of seal(s) with a grease cartridge. The lead-in protrusion assist in centering of a filled grease cartridge and the dome assists in formation of the inside seal with the inner ring outer surface and the interior surface of the cartridge and the outside seal with the outer ring member and the exterior of the cartridge.

As discussed above, during the cooling of grease, the inner ring member moves away from the center of the cartridge, due to cooling effects, and forces itself against the inside surface of the grease cartridge, and when grease inside the cartridge cools, it the inner ring seals the inside surface of the grease cartridge. The dome contracts and creates a pinch point thereby assisting in the formation of the inside seal, and the gap between the outer ring member and the inner ring member closes to pinch or grip the grease cartridge, around the circumference of the grease cap and grease cartridge.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A grease cap for a grease cartridge, comprising:
a) a sealing member comprising:
an outer ring member having an inner surface configured to sealingly engage with a cylindrical exterior surface of the grease cartridge, the outer ring member defining and surrounding a cylindrical cavity,
an inner ring member having an outer surface configured to sealingly engage with a cylindrical interior surface of the grease cartridge, the inner ring member located within the cylindrical cavity, and
a connecting body connecting a top edge of the inner ring member to a top edge of the outer ring member; and
b) a cover member connected to the sealing member, wherein the sealing member and the cover member together define an enclosed space (or form a cap) for receiving an open top portion of the grease cartridge.

2. The grease cap of claim 1, wherein the cover member is connected at or adjacent to a bottom edge of the inner ring member.

3. The grease cap of claim 1, wherein the cover member is connected at or adjacent to a top edge of the inner ring member.

4. The grease cap of claim 1, wherein the cover member is connected to the connecting member.

5. The grease cap of claim 1, wherein the cover member is dome-shaped.

6. The grease cap of claim 1, wherein the inner ring member further includes a lead-in protrusion extending from the bottom edge of the inner ring member.

7. The grease cap of claim 1, further comprising a vent formed as a localized indentation in the inner surface of the outer ring member, the vent located away from the top edge of the outer ring member and occupying less than the entire circumference of the outer ring member.

8. The grease cap of claim 1, further comprising a plurality of regularly spaced vents, each vent formed as a localized indentation in the inner surface of the outer ring member and/or outer sidewall of the inner ring member, each vent located away from the top edge of the outer ring member and occupying less than the entire circumference of the outer ring member.

9. The grease cap of claim 7 or 8, wherein the vents are sized not to extend into the sealing engagement of the outer ring member with the cylindrical exterior surface of the grease cartridge.

10. The grease cap of claim 1, wherein at least the outer ring member is made of flexible material.

11. The grease cap of claim 1, wherein at least the connecting member is flexible and resilient.

12. The grease cap of claim 1, wherein an inner face of the connecting body is configured to sealingly engage a top edge of the grease cartridge.

13. The grease cap of claim 1, wherein the entire cap is made of flexible and resilient material.

14. The grease cap of claim 2, wherein the cover member is dome shaped.

15. The grease cap of claim 14, further comprising a plurality of regularly spaced vents, each vent formed as a localized indentation in the inner surface of the outer ring member, each vent located away from the top edge of the outer ring member and occupying less than the entire circumference of the outer ring member.

16. The grease cap of claim 15, wherein the vents are sized not to extend into the sealing engagement of the outer ring member with the cylindrical exterior surface of the grease cartridge.

17. The grease cap of claim 16, wherein the edges of the cover member are integral with the bottom edge of the inner ring member.

18. The grease cap of claim 17, wherein the top edge of the outer ring member, the top edge of the inner ring member, the connecting body and the edges of the cover member are integral.

19. The grease cap of claim 18, wherein the inner ring member further includes a lead-in protrusion extending from the bottom edge of the inner ring member.

20. The grease cap of claim 19, wherein at least the connecting member is flexible and resilient.
